(19) United States
(12) Patent Application Publication
(10) Pub. No.: US 2010/0002970 A1
(43) Pub. Date: Jan. 7, 2010

(54) Joint Bush

(76) Inventor: Heiko Schmidt, Lappersdorf (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/308,412

(22) PCT Filed: May 3, 2007
(86) PCT No.: PCT/DE2007/000787

§ 371 Date: Dec. 15, 2008

(30) Foreign Application Priority Data
May 10, 2006 (DE) 10 2006 021 992.9
Jul. 6, 2006 (DE) 10 2006 031 289.9

(51) Int. Cl. F16C 17/10

(52) U.S. Cl. 384/231

(57) ABSTRACT

The invention relates to a joint bush, for use in a joint between two components or workpieces, comprising a first sleeve-like bush section, which transforms at one sleeve end into a second flange-like bush section which projects over the circumferential surface of the first bush section.

### BACKGROUND OF THE INVENTION

The invention relates to a joint bush for use in a linkage between two components or workpieces.

Joints between two components or workpieces are needed in a wide range of technical areas, also in automobile construction or automotive technology, for example in so-called linkages, e.g. between the vehicle body and a moveable body element, e.g. between the vehicle body and an engine hood or a trunk lid. Such joints are also needed in other technical areas and generally consist of a joint bush held torsionally stable in a component and of a joint pin, which can rotate or pivot with a bush section in the joint bush, the joint pin being secured against axial displacement so that it bears with a pin head on the first component or on a flange-like section of the bearing or joint bush and being fastened in the second component in a suitable manner, for example by riveting. The joint bushes used are designed with very thin walls, making controlled machining of such bushes difficult. In particular, it is possible that problems may arise during the feeding of such bushes, namely for example if bushes arranged adjacent to each other in a guide are pushed one over the other, causing them to jam in the guide.

It is an object of the invention is to present a joint bush that prevents such disadvantages.

### SUMMARY OF THE INVENTION

In the joint bush according to the invention, which preferably is manufactured by rolling a suitable flat metal material for such bush joints, for example sheet steel, the flange-like bush section is formed so that its exposed edge encloses the sleeve-like bush section and is at an axial distance from both ends of the bush. This provides improved support, for example of adjacent joint bushes in a guide on their flange-like bush section.

### BRIEF DESCRIPTION OF THE DRAWINGS

The invention is described in more detail below based on an exemplary embodiment with reference to the drawings, in which:

FIG. 1 shows a simplified representation of a joint formed between two components, consisting essentially of a joint bush and a joint pin;

FIG. 2 shows an enlarged representation in cross section of a joint bush prior to assembly;

FIG. 3 shows several joint bushes in a guide of a set head; and

FIG. 4 shows in a representation similar to FIG. 2 a further embodiment of the joint bush prior to assembly.

### DETAILED DESCRIPTION OF THE INVENTION

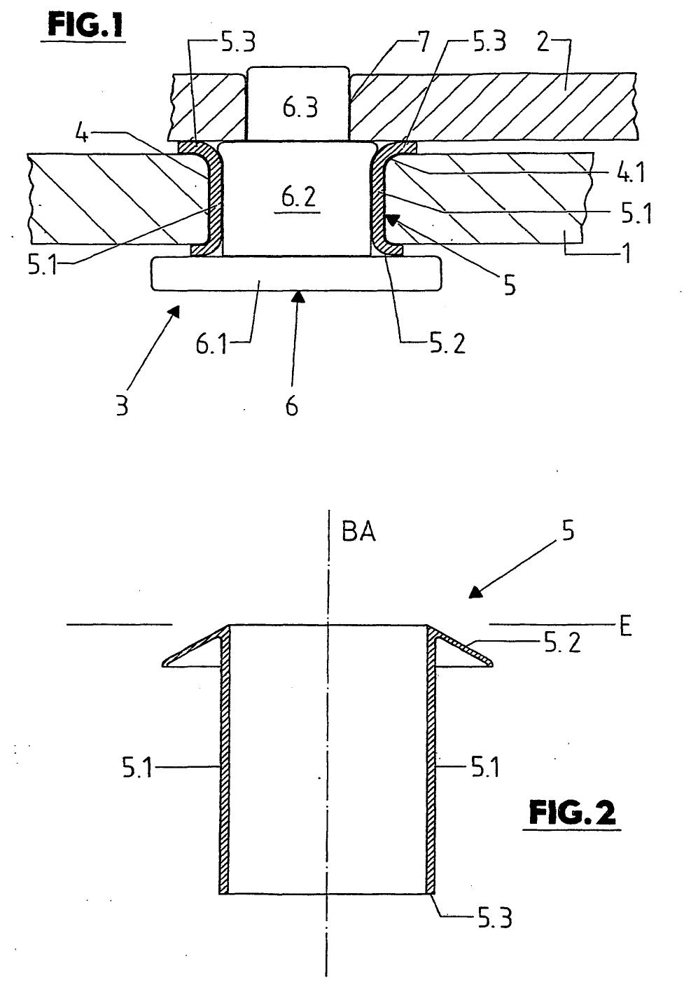

In FIG. 1, 1 and 2 designate two workpieces or components manufactured from metal, e.g. sheet metal by punching and bending and which are connected with each other by means of a joint 3. The components 1 and 2 are, for example, elements of a linkage.

The joint 3 consists essentially of a joint bush inserted into an opening 4 of the component 1, which (joint bush) is manufactured from a thin material suitable for joint bushes, for example from steel, with a sleeve-like bush section 5.1 and a projecting flange 5.2. The bush 5 is inserted into the opening 4 so that it bears with the flange 5.2 on the edge of the opening 4 of a surface of the component 1 facing away from the component 2 and is held with the bush-like section 5 in the opening 4. To secure the bush 5, the sleeve-like section 5.1 is bent around the end 5.3 facing away from the flange-like section 5.2 on the edge of the opening 4 there. Further, the bush 3 consists of the joint pin 6, which comprises a pin head 6.1 and an adjoining pin section 6.2 with a larger diameter and adjoining the latter a pin section 6.3 with a reduced diameter. The joint pin 6 is held in the bush 5 with the pin section 6.2, so that the pin head 6.1 bears against the flange-like section 5.2. The joint pin 6 engages with the section 6.3 in an opening 7 of the component 2 and is anchored there by riveting, for example using a wobble rivet process.

The linkage 3 is manufactured for example as follows: the bushes 5 are inserted respectively into an opening 4 of a workpiece 1 using a suitable tool, for example a set head, and then calibrated in the opening 4 using a suitable calibration and bending tool, during which also the bush edge 5.3 is bent, namely so that the flange-like section 5.2 bears as evenly as possible against the one surface side of the workpiece 1 on the edge of the opening 6 and the bent bush edge 5.3 bears against the other surface side of the workpiece 1 on the edge of the opening 4 there, thus forming the lateral bearing and sliding surface for the component 1. A suitable tool is then used to insert the joint pin 6 into the bush thus provided on the workpiece 1.

As described, the bushes 5 are manufactured with very thin walls, namely by rolling a flat material, this rolling process also being used to manufacture the flange-like section 5.2.

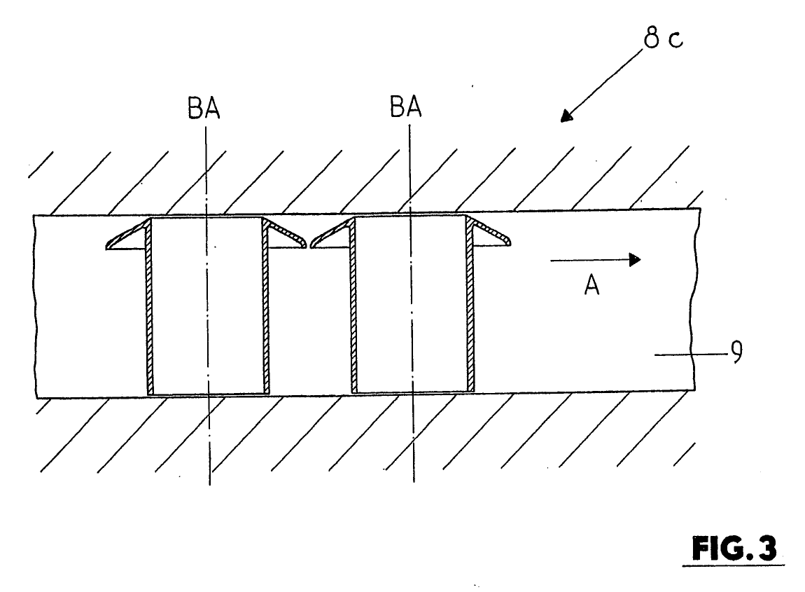

As depicted in FIG. 2, the flange-like section 5.2 is not designed so that its surface sides are located in a plane perpendicular to the bush axis BA; instead, the section 5.2 is bent toward the sleeve-shaped section 5.1, so that the outer exposed edge of the section 5.2 at the furthest distance from the bush axis BA is at a distance from the plane E in an axis direction parallel to the bush axis BA. This plane is the plane of the upper bush opening in FIG. 2, i.e. of the bush opening formed by the transition between the sections 5.1 and 5.2. The section 5.2 therefore has an essentially truncated cone shape, namely with an angle of taper that is open toward the end 5.3. Other shapes of the section 5.2 formed with its outer edge in the direction of the sleeve-like section 5.1 are also possible, for example in the manner that this section is convex or curved at least in a partial area, as depicted in FIG. 3.

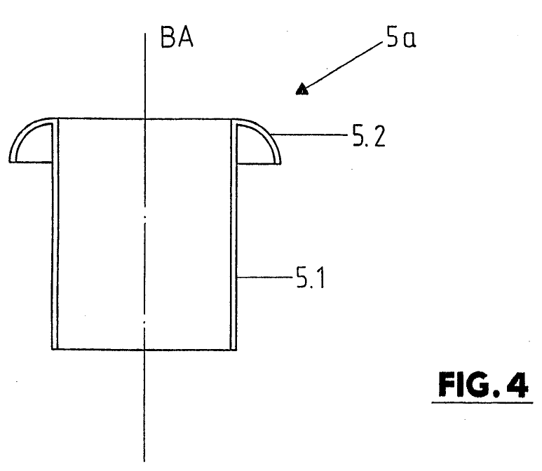

The special shape of the joint bush 5 or 5a enables simplified and controlled machining of these bushes; in particular, the feeding of the bushes 5 or 5a is simplified. FIG. 4 shows in a very schematic representation a guide 8, for example of a bush set head. The guide 8 forms a channel 9, in which the joint bushes 5 or 5a are moved for example by carrier air in a direction of transport A, namely to a pick-up position of the bush set head, at which then the bushes can be inserted consecutively into an opening 4 of a workpiece 1.

In the channel 9, the bushes 5 are arranged closely adjacent to each other and are oriented with their bush axis BA perpendicular to the direction of transport A. Adjacent bushes bear against each other respectively with their outer edge of the section 5.2, which due to its slight convexity forms a relatively large surface in comparison with the material thickness of the joint bushes 5 for the respective adjacent joint bush, thus preventing adjacent joint bushes from being pushed into each other on their flange-like sections 5.2 in the channel 9 or in the guide 8.

Since the bent section 5.2 of the respective joint bush 5 is deformed during insertion and fixing in the opening 4 so that the section 5.2 bears evenly against the one surface side of the workpiece 1 at the edge area of the opening 4, the inherent elasticity of the material used for the bushes 5 provides additional anchoring of the bushes 5 in the workpiece 1 due to resilient contact of the sections 5.2.

The invention was described above based on an exemplary embodiment. It goes without saying that modifications and variations are possible. For example, it is possible to design the respective section 5.2 so that it is entirely convex, as depicted in FIG. 4 for the joint bush 5a.

### REFERENCE LIST

1, 2 component
3 joint
4 opening
5, 5a joint bush
5.1 sleeve-like bush section
5.2 flange-like bush section or flange
5.3 bent bush section
6 joint pin
6.1 head
6.2, 6.3 pin section
7 opening in component or workpiece 2
8 guide
9 guide channel
A direction of transport
E plane
BA bush axis

What is claimed is:

1. A joint bush for use in a linkage between two components or workpieces comprising a first, sleeve-like bush section, which transforms on a sleeve end into a second, flange-like bush section, which projects over a circumferential surface of the first bush section wherein the second bush section encloses with its exposed edge the first bush section and is at a distance from the first sleeve end in an axis direction parallel to the bush axis (BA).

2. The joint bush according to claim 1, wherein the joint brush is manufactured from a flat material, or a flat metal material.

3. The joint bush according to claim 2, wherein the joint brush is manufactured from the flat metal material by rolling.

4. The joint bush according to claim 1, wherein the second bush section has a truncated cone or tapered ring design.

5. The joint bush according to claim 1, wherein the second bush section has a convex design at least in partial areas.
